(19) United States
(12) Patent Application Publication
(10) Pub. No.: US 2025/0371266 A1
(43) Pub. Date: Dec. 4, 2025

(54) METHODS AND SYSTEMS FOR REHABILITATING NONCOMPLIANT MESSAGES

(71) Applicant: Sequelae, Inc., Minneapolis, MN (US)

(72) Inventors: Scott Archibald, Wayzata, MN (US); Mark Briesacher, Park City, UT (US); Sara Taylor, Edina, MN (US); Salomea Anna Jankovic, Minneapolis, MN (US); Duncan Hieu Minh Dam, Palm Springs, CA (US); Ryan Michael Rodeback, Edina, MN (US)

(73) Assignee: Sequelae, Inc., Minneapolis, MN (US)

(21) Appl. No.: 19/216,284

(22) Filed: May 22, 2025

Related U.S. Application Data
(60) Provisional application No. 63/652,508, filed on May 28, 2024.

(51) Int. Cl. G06F 40/242; G06F 40/253

(52) U.S. Cl. CPC G06F 40/242; G06F 40/253

(57) ABSTRACT

Methods and systems for rehabilitating a noncompliant message are provided. A digital communication network (DCN) is provided to a plurality of members of a population to interact with each other. A communication of a plurality of communications in the DCN is received from an individual member and the communication is analyzed. The communication is determined to be noncompliant and thus, access of the communication is limited to at least a subset of members of the population.

### CROSS REFERENCE TO RELATED APPLICATIONS

This application claims the benefit of U.S. Provisional Application No. 63/652,508, filed on May 28, 2024, which application is incorporated herein by reference in its entirety.

### BACKGROUND

Various embodiments relate generally to digital communication, methods, devices and computer programs and, more specifically, relate to rehabilitation of noncompliant messages in a digital communication network.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Computers have changed the way people interact. Digital communication networks (DCN), which can include social media where individuals can interact with others online, connect many with a community. The online community can be utilized to help build positive behaviors and encourage people to make improvements in their lives. Additionally, computers have enabled new ways to get people to view their situations.

However, content posted to a DCN may not be appropriate for the network. Such messages may be noncompliant with the standards and rules established for the DCN (or for a subset of the DCN). In some cases, the posts may be made in a deliberate desire to misinform. In other instances, the content may unintentionally violate standards for a post to the network. For example, the post may use improper language, contain offensive language, incorrectly state information, etc. Removing any such posts risks dissuading the poster from contributing to the DCN and can stifle robust communication.

What is needed is a way to rehabilitate noncompliant messages in a digital communication network which does not discourage new posts.

### SUMMARY

Example aspects of the present disclosure include:

A method to rehabilitate messages in a digital communication network (DCN) according to at least one embodiment of the present disclosure comprises providing the DCN for a plurality of members of a population to interact with each other and the DCN; receiving a communication of a plurality of communications in the DCN from an individual member of the plurality of members; automatically analyzing the communication; determining if the communication is noncompliant; and limiting access of the communication to a subset of members of the plurality of members in response to determining that the message is noncompliant.

Any of the aspects herein, wherein the communication is part of a communication string, and wherein the communication is evaluated in the context of the communication string.

Any of the aspects herein, further comprising: receiving at least one of a new communication added to the communication string or a modification to the communication string; and reanalyzing the communication based on at least one of the new communication or the modification.

Any of the aspects herein, wherein the subset of members can add communications to the communication string.

Any of the aspects herein, wherein the subset of members is determined, in part, by at least one of: a type of noncompliance, a degree of noncompliance, through analysis of the subset of members interactions DCN, and a topic of the communication string.

Any of the aspects herein, wherein analyzing the communication comprises classifying a type of noncompliance of the communication.

Any of the aspects herein, wherein the type of noncompliance communication comprises, at least one of: an obscene message, a message that disparages a group or individual, a message with misinformation, a message which is cruel, a message with commercial intent, a message with inappropriate medical advice, a message with confusing or out of context advice, a message with unsafe advice, a message with illegal content, a message which discourages adoption of a health behavior, and a message which diminishes self-efficacy or agency.

Any of the aspects herein, wherein analyzing the communication comprises classifying a degree of noncompliance of the communication.

Any of the aspects herein, wherein the subset of members can communicate directly with the individual member.

Any of the aspects herein, further comprising: providing the individual member an interface to modify the communication to generate a revised communication; receiving the revised communication; and communicating the revised communication to the DCN.

Any of the aspects herein, further comprising, in response to determining the communication is noncompliant, flagging the communication in a communication feed.

Any of the aspects herein, wherein the flagging indicates at least one of a type of noncompliance, a degree of noncompliance, or a combination thereof.

Any of the aspects herein, wherein the method is used to at least one of: manage health care cost of the population; reduce health care risk in the population; and slow progression of an adverse health condition.

Any of the aspects herein, wherein the communication string is restricted to the subset of members of the DCN.

A method to rehabilitate communications in a digital communication network (DCN) according to at least one embodiment of the present disclosure comprises
providing the DCN for a plurality of members of a population to interact with each other and the DCN; receiving a communication of a plurality of communications in the DCN from an individual member of the plurality of members; automatically analyzing the communication; determining if the communication is noncompliant; and sending, in response to determining the communication is noncompliant, the user a communication containing a link to a second network where the communication would meet online community rules and standards.

Any of the aspects herein, wherein the noncompliant communication comprises at least one of: an obscene communication, a communication that disparages a group or individual, a communication with misinformation, a communication which is cruel, a communication with commercial intent, a communication with inappropriate medical advice, a communication with confusing or out of context advice, a communication with unsafe advice, a communication with illegal content, a communication which discourages adoption of a health behavior, and a communication which diminishes self-efficacy or agency.

Any of the aspects herein, wherein the link to the second network is accompanied by a message encouraging the individual member to use the second network to propagate content of the noncompliant communication.

Any of the aspects herein, further comprising, after a time period, sending the individual member an invitation to return to the DCN and share experiences related to interactions on the second network.

Any of the aspects herein, wherein the time period is at least one week.

Any of the aspects herein, wherein the second network is selected automatically based on communications by the individual member.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

Aspects of the described embodiments are more evident in the following description, when read in conjunction with the attached Figures.

FIG. 1 shows a simplified block diagram of devices, in accordance with one or more embodiments.

FIG. 2 is a logic flow diagram that illustrates the operation of a method, in accordance with one or more embodiments.

FIG. 3 is a logic flow diagram that illustrates the operation of a method, in accordance with one or more embodiments.

FIG. 4 is a logic flow diagram that illustrates the operation of a method, in accordance with one or more embodiments.

FIG. 5 is a logic flow diagram that illustrates the operation of a method, in accordance with one or more embodiments.

FIG. 6A shows an example of a computing system, in accordance with one or more embodiments.

FIG. 6B shows an example of a network, in accordance with one or more embodiments.

### DETAILED DESCRIPTION

Various embodiments are directed to rehabilitation of noncompliant messages in a DCN. Members of the DCN have the freedom to post messages in order to foster the exchange of information. However, sometimes, the users may post messages that do not conform with the standards of the DCN.

A noncompliant message may include, for example, noncompliant content and noncompliant content is unavoidable on a DCN. Noncompliant content includes messages or posts which are malformed and have a deliberate desire to misinform for any number of motivations. In addition, noncompliant content may also include messages that unintentionally violate the rules of the DCN. Unintentional violations can occur for many reasons, such as, sloppy use of language, lack of awareness of other data, writing during an emotional situation, etc.

Regardless of the reason for the noncompliant content, the owners of digital social networks often desire to remove some of this content. The reasons may include a sense of social responsibility to prevent the spread of misinformation, to philosophical viewpoints, to avoiding offending other uses of the network.

Conventional methods to limit noncompliant content and moderate its impact include quarantining the noncompliant content. However, quarantining noncompliant content, as done in many systems, can discourage well-intentioned individuals from continued posting and loses the value of potentially useful content. On a DCN which is aimed at helping people slow the progression of disease, communications (both positive and noncompliant) need to be managed correctly. Failure to do so risks preventing the DCN from achieving its purposes.

Encouraging strong online communities can benefit its members in many ways. The use of the community (and the DCN and apps which connect patients to the community) can help overcome many limitations members of the community may experience. As one example, the community teaches and encourages members to discover their individual biological marker levels (such as for chronic systemic inflammation (CSI)) and, often more importantly, whether it is increasing or decreasing. The community encourages individuals to share what they are doing and how it impacted their condition. Finally, other members of the community can use those experiences to find things they can try and share.

Online communities can be supported by members sharing their experience, such as by posting, so that more people can learn about healthy lifestyle practices and work to improve their health between clinical touchpoints, such as office visits. To help incentivize healthy behaviors, patients can use tools like in-home tests and biosensors that measure how well their health actions are working.

Online programs can also give access to information and guidance to help patients discover healthy actions that may work best for them. They can also find a community of patients and others who can support them and who they can support through online or arranged in-person conversations. Using their personal computers or devices (such as a cell phone), patients can have access to activity trackers, health testing, etc. as well as other tools aimed at improving their health. Such information may be gathered from connected devices, such as, glucose measurements from a continuous glucose monitor, and wearables like Fitbit. Patients and doctors can also communicate to address issues like food, transportation, and other factors that impact their health.

In many situations, patients can use their personal devices, such as a computer, tablet, cell phone, etc., to interact with a host system on a server. The host system can provide a platform for relaying communications, such as public posts, etc. and/or direct messages. Additionally, the host system can store patient/user information, for example, biometric information, test results, personal data, etc. In some embodiments, the host system may provide services/apps, e.g., monitoring or even games.

Thus, it is desirable to encourage continued interaction between members through the DCN while also providing a way for a member to rehabilitate noncompliant communications to incentivize the member's continued interactions with other members and the DCN.

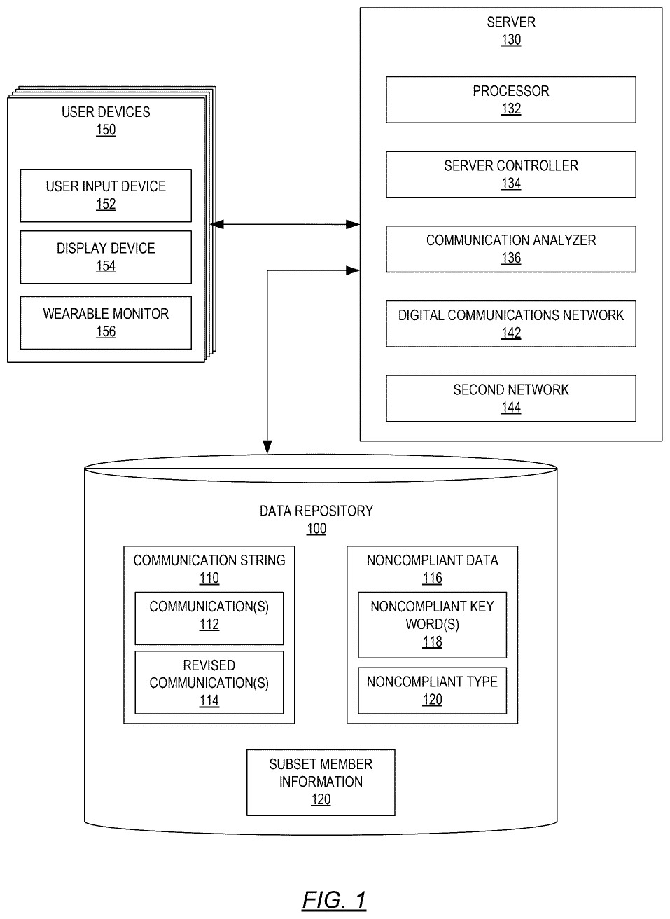

Turning to the Figures, the system shown in FIG. 1 includes a data repository (100). The data repository (100) is a type of storage unit or device (e.g., a file system, database, data structure, or any other storage mechanism) for storing data (described below). The data repository (100) may include multiple different, potentially heterogeneous, storage units and/or devices.

The data repository (100) stores communication strings (110). The communication strings (110) may be formed from one or more communications (112). The communications (112) are communications from members in the DCN (142). The communications may be, for example, text-based, image-based, multimedia communications, audio communications, or any combinations thereof. The communications may be between members, communications in a forum, communications with the DCN (142), or communications generated by the DCN (142) (e.g., communications from a chatbot). Communications (112) can be added to, removed from, or modified in the communication strings (110). A communication (112) can also be modified to yield a revised communication (114) within the communication string (110). In other embodiments, the revised communication (114) can also be a standalone communication.

The data repository (100) also stores noncompliant data (116). The noncompliant data (116) is data that can be used to determine whether a communication (112) is a noncompliant communication. For example, the noncompliant data (116) includes noncompliant key words (118) that correlate to noncompliant communications. Thus, the communication (112) can be searched for the noncompliant key words (118) to determine if the communication (112) is noncompliant. Other data such as syntax, a topic of the communication, and information about sources or members who typically produce noncompliant communications can also be used to determine if the communication (112) is noncompliant.

The noncompliant data (116) also includes noncompliant type (120), which can be used to label or flag a communication (112) as a specific noncompliant type (120). The noncompliant type (120) can be, for example, an obscene message, a message that disparages a group or individual, a message with misinformation, a message which is cruel, a message with commercial intent, a message with inappropriate medical advice, a message with confusing or out of context advice, a message with unsafe advice, a message with illegal content, a message which discourages adoption of a health behavior, and/or a message which diminishes self-efficacy or agency.

The data repository (100) also stores subset member information (120). The subset member information (120) includes at least identification of the members in the subset of members. The subset member information (120) may also include information that is common to the members of the subset. For example, the members of the subset may live in the same region. In another example, the members of the subset may be grouped based on a type of noncompliance and/or a degree of noncompliance that the members are opposed to, through analysis of the members interactions in the DCN, and/or a topic of the communication string.

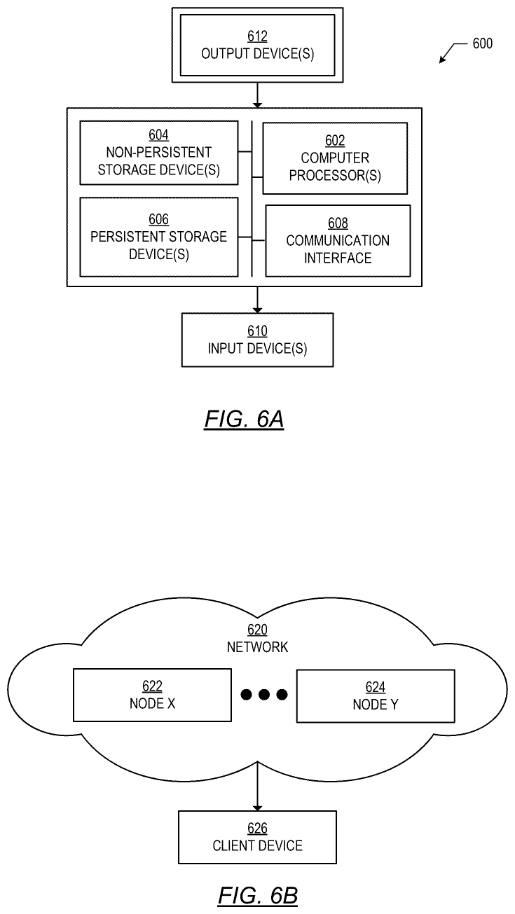

The system shown in FIG. 1 may include other components. For example, the system shown in FIG. 1 also may include a server (130). The server (130) is one or more computer processors, data repositories, communication devices, and supporting hardware and software. The server (130) may be in a distributed computing environment. The server (130) is configured to execute one or more applications, such as a training controller (136), an activity controller (138), or a stress resiliency generator (140). An example of a computer system and network that may form the server (130) is described with respect to FIG. 6A and FIG. 6B.

The server (130) also includes a computer processor (132). The computer processor (132) is one or more hardware or virtual processors which may execute computer readable program code that defines one or more applications, such as a communication analyzer (136). An example of the computer processor (132) is described with respect to the computer processor(s) (602) of FIG. 6A.

The server (130) also may include a server controller (134). The server controller (134) is software or application specific hardware which, when executed by the computer processor (132), controls and coordinates operation of the software or application specific hardware described herein. Thus, the sever controller (138) may control and coordinate execution of the communication analyzer (136).

The server (130) also includes the communication analyzer (136). The communication processor (140) is software or application specific hardware which, when executed by the computer processor (132), determines whether the communication (112) is noncompliant. For example, the communication analyzer (136) receives, as input, the communication (112) and the noncompliant data (116) and outputs whether the communication (112) is noncompliant or not noncompliant.

The server (130) also includes a digital communications network (DCN) (142). The DCN is a network through which members of a population can interact with each other, or with a system supported by the DCN. For example, the members of the population can communicate and send communications (112) to each other. The members may also add communications (110) to, remove communications (112), or modify communications (112) in the communication string (110). The DCN (142) can also separate out a subset of members for which a noncompliant communication (112) can be sent to or restricted from.

The DCN (142) may include sub-groups which have their own standards. For example, a sub-group for adults may be more permissive regarding various topics and language used than a sub-group for children. Additionally, the DCN (142) may attempt to prevent the spread of disinformation.

The system (100) also includes a second network (144). The second network (114) may be the same as or similar to the DCN (142), but may be a network separate from the DCN (142) or a subset of the DNC (142). The second network (144) may have online community standards and/or rules that are different from the DCN (142). For example, a communication (112) may not meet the online community standards and/or rules of the DCN (142), but may meet the online community standards and/or rules of the second network (144). In another example, the communication (112) may include offensive words that do not meet the online community standards and/or rules of the DCN (142), but do not violate the online community standards and/or rules of the second network (144). Thus, in some embodiments, the individual member may be asked to move their communications (112) that are deemed to be noncompliant to the second network (144).

The system shown in FIG. 1 also may include one or more user devices (150). The user devices (150) may be considered remote or local. A remote user device is a device operated by a third-party (e.g., an end user of a chatbot) that does not control or operate the system of FIG. 1. Similarly, the organization that controls the other elements of the system of FIG. 1 may not control or operate the remote user device. Thus, a remote user device may not be considered part of the system of FIG. 1.

In contrast, a local user device is a device operated under the control of the organization that controls the other components of the system of FIG. 1. Thus, a local user device may be considered part of the system of FIG. 1.

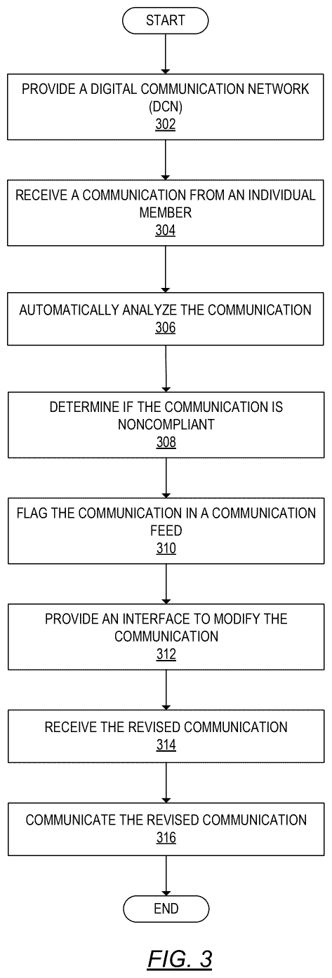

In any case, the user devices (150) are computing systems (e.g., the computing system (300) shown in FIG. 3A) that communicate with the server (130). The user devices (150) may include a wearable monitor (156) and be configured to send stress indicator data (110) to the server (130). In an alternative embodiment, a separate wearable device may be in communication with the user device (150), such as a smart watch, or blood pressure monitor. The user devices (150) may also include a user input device (152) and/or a display device (154).

In contrast, a local user device is a device operated under the control of the organization that controls the other components of the system of FIG. 1. Thus, a local user device may be considered part of the system of FIG. 1.

While FIG. 1 shows a configuration of components, other configurations may be used without departing from the scope of one or more embodiments. For example, various components may be combined to create a single component. As another example, the functionality performed by a single component may be performed by two or more components.

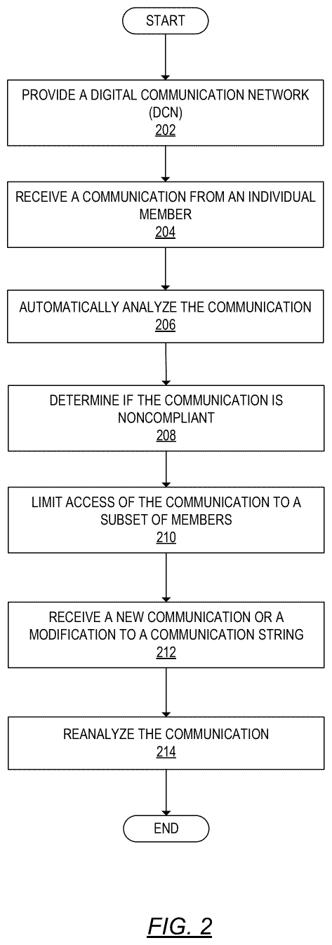

FIG. 2 is a logic flow diagram that illustrates a method, and a result of execution of computer program instructions, in accordance with various embodiments. The method can be used to determine if a communication is noncompliant and restrict or limit access to communications that are determined to be noncompliant.

At Block 202, a step of providing a digital communication network (DCN) is provided. The DCN may be the same as or similar to the DCN (142) and provides a network for members of a population to interact with each other or with the DCN (142).

At Block 204, a step of receiving a communication from an individual member is provided. The communication may be the same as or similar to the communication (112). The communication may be created by the individual member for posting in a community forum, on the individual member's personal page, or in any other service provided by the DCN. The communication may be analyzed prior to publishing or becoming public to the population in the DCN.

At Block 206, a step of automatically analyzing the communication is provided. The communication may be analyzed by, for example, a communication analyzer such as the communication analyzer (136). The communication analyzer may receive the communications from the Block 204 and noncompliant data such as the noncompliant data (116) and output whether the communication is noncompliant or not noncompliant. The communication analyzer uses the noncompliant data such as noncompliant key words (which may be the same as or similar to the noncompliant key words (118)) to determine if the communication is noncompliant or not noncompliant, as will be described below.

In some embodiments, analyzing the communication also includes classifying a degree of noncompliance of the communication. In other words, the message may be analyzed to determine how noncompliant the communication is.

In some embodiments, the step of automatically analyzing the communication may also include classifying a type of noncompliance of the communication. The type of noncompliance can be the same as or similar to the noncompliant type (120). The type of noncompliance can be used to determine a subset of members to which the communication should be restricted from. The type of noncompliance can also be used to identify or determine future communications that are the same type of noncompliance, which can then be used to determine that the communication is noncompliant.

In other embodiments, the step of automatically analyzing the communication may include quarantining the communication for review by a select group of members, for example, administrators. The administrators may be provided the tools to override the decision, permanently remove the post, or take other responsive measures. The moderators may also be able to change (or recommend) settings which caused the message to be flagged as violating the standards (or noncompliant).

At Block 208, a step of determining if the communication is noncompliant is provided. In at least one embodiment, the communication analyzer may do a keyword search of the communication for the noncompliant key words, and if a noncompliant key word is found, then the communication is determined to be noncompliant. The communication analyzer may also analyze a syntax or a context of the communication, who created the communication, and where the communication is being posted.

In some embodiments, the communication is part of a communication string such as the communication string (110). In such embodiments, the communication is evaluated in the context of the communication string. For example, an initial communication such as “I read blood pressure medicine does not work” may be in a communication string in which other communications provide facts and/or anecdotes showing the effectiveness of blood pressure medicine or other alternative medications. Thus the initial communication may be read in the context of the entire communication string in which helpful discussion regarding the initial communication may take place in the communication string.

At Block 210, a step of limiting access of the communication to a subset of members is provided. The communication may be limited to the subset of members as defined by subset member information such as the subset member information (120). For example, the communication may be restricted and cannot be viewed by a subset of members that are below an age limit. In another example, the communication may be available only to a subset of members that are above the age limit. In some instances the subset of members is determined, in part, by at least one of: a type of noncompliance, a degree of noncompliance, through analysis of the subset of members interactions DCN, and a topic of the communication string.

Graphs of the DCN may also be used to identify sub-communities of the population for the user to interact with. Such communities may be a self-identified group (e.g., members in a conversation thread) or one found by analysis of communication topics shared between members.

At Block 212, a step of receiving a new communication or a modification to a communication string is provided. The communication string may be the same as or similar to the communication string (110). The new communication or modification to the communication string may be received from the individual member or another member of the plurality of members.

At Block 214, a step of reanalyzing the communication is provided. Reanalyzing the communication includes evaluating the communication in light of the new communication added to the communication string or the modification to the communication string. For example, the communication may not be deemed to be noncompliant if the communication string is modified so as to provide a different context to the communication.

The method described in FIG. 2 may have more or less steps and any steps or combinations of steps may be repeated.

FIG. 3 is a logic flow diagram that illustrates a method, and a result of execution of computer program instructions, in accordance with various embodiments. The method can be used to determine if a communication is noncompliant and allow an individual member to modify the communication if the communication is determined to be noncompliant.

At Block 302, a step of providing a digital communication network (DCN) is provided. The Block 302 is the same as or similar to the Block 202 of FIG. 2 described above.

At Block 304, a step of receiving a communication from an individual member is provided. The Block 304 is the same as or similar to the Block 204 of FIG. 2 described above.

At Block 306, a step of automatically analyzing the communication is provided. The Block 306 is the same as or similar to the Block 206 of FIG. 2 described above.

At Block 308, a step of determining if the communication is noncompliant is provided. The Block 308 is the same as or similar to the Block 208 of FIG. 2 described above.

At Block 310, a step of flagging the communication in a communication feed is provided. The communication may be flagged when the communication is determined to be noncompliant. The flagging may indicate a type of noncompliance and/or a degree of noncompliance.

At Block 312, a step of providing an interface to modify the communication is provided. The interface may be provided to the individual member via a user device such as the user device (150). The interface may include an invitation to the individual member to modify the communication and may inform the individual member that the communication does not comply with the DCN community standards or rules. Suggestions, guidelines (e.g., DCN community standards or rules), or recommendations on how to modify the communication may also be provided to the individual member.

At Block 314, a step of communicating the revised communication is provided. The revised communication may be analyzed to determine if the revised communication is still noncompliant or is no longer noncompliant. If the revised communication is not noncompliant, then revised communication may be communicated to the subset of members or all members of the population. In some embodiments, the revised communication may not be reanalyzed and may simply be communicated to the subset of members or all members of the population.

The method described in FIG. 3 may have more or less steps and any steps or combinations of steps may be repeated.

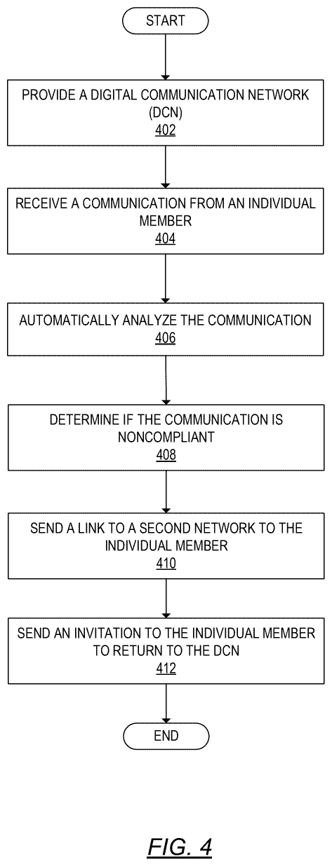

FIG. 4 is a logic flow diagram that illustrates a method, and a result of execution of computer program instructions, in accordance with various embodiments. The method can be used to determine if a communication is noncompliant and to send the communication to a second network if the communication is determined to be noncompliant.

At Block 402, a step of providing a digital communication network (DCN) is provided. The Block 402 is the same as or similar to the Block 202 of FIG. 2 described above.

At Block 404, a step of receiving a communication from an individual member is provided. The Block 404 is the same as or similar to the Block 204 of FIG. 2 described above.

At Block 406, a step of automatically analyzing the communication is provided. The Block 406 is the same as or similar to the Block 206 of FIG. 2 described above.

At Block 408, a step of determining if the communication is noncompliant is provided. The Block 408 is the same as or similar to the Block 208 of FIG. 2 described above.

At Block 410, a step of sending a link to a second network to the individual member is provided. The second network may be the same as or similar to the second network (144). The link may be sent when the communication is determined to be noncompliant. The second network may have rules or standards that are different from the rules or standards of the DCN. Thus, the individual member may be provided with access to the second network where the noncompliant communication may meet the rules or standards. In such instances, the individual member may also be sent a message encouraging the individual member to use the second network to propagate content of the noncompliant communication.

The second network may be selected from any number of networks external to the DCN. The second network may be selected based on communications by the individual member. For example, the second network may be selected based on whether the communications by the individual member would not violate the rules and standards of the second network.

Alternatively, the DCN may select the new group for the original posting member, in part, to encourage the spread of ideas into the new group. This may be based on an analysis of the content of the message, for example, to identify the general topic. The digital communication network may then select the new group so that it is both appropriate for the message and could benefit from the content of the message.

In an alternative embodiment, the DCN may review post for content and recommend re-posting to a different group, regardless to whether the post is malformed. This can encourage the spread of information to new groups.

At Block 412, a step of sending an invitation to the individual member to return to the DCN is provided. The invitation to the individual member may be sent after a time period. The time period may be, for example, at least one hour, day, week, month, etc. The invitation may also include a message to the individual member to share their experiences related to interactions on the second network.

The method described in FIG. 4 may have more or less steps and any steps or combinations of steps may be repeated.

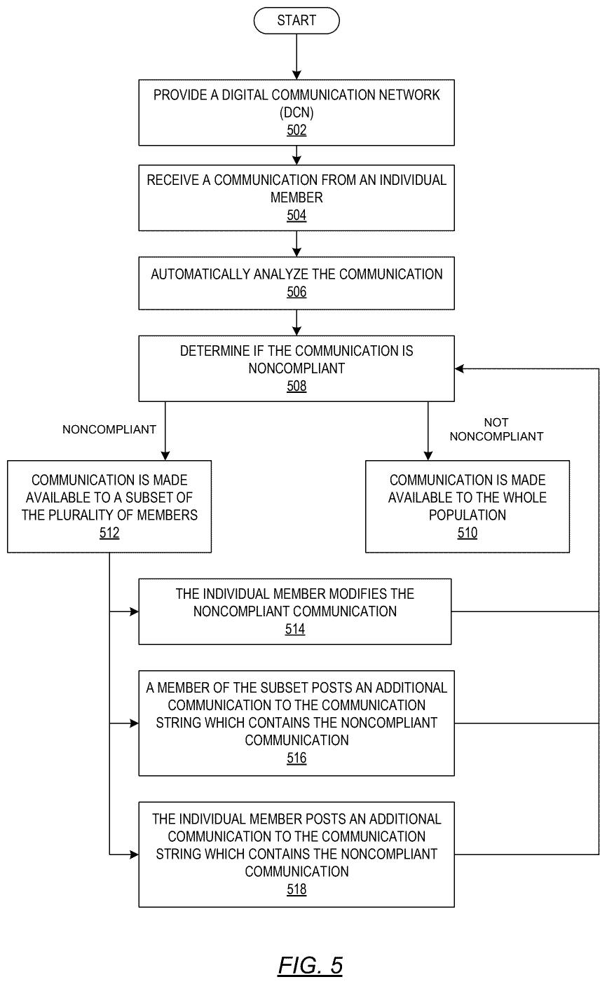

FIG. 5 is a logic flow diagram that illustrates a method, and a result of execution of computer program instructions, in accordance with various embodiments. The method can be used to determine if a communication is noncompliant and to restrict or limit the communication to a subset of members if the communication is determined to be noncompliant.

At Block 502, a step of providing a digital communication network (DCN) is provided. The Block 502 is the same as or similar to the Block 202 of FIG. 2 described above.

At Block 504, a step of receiving a communication from an individual member is provided. The Block 504 is the same as or similar to the Block 204 of FIG. 2 described above.

At Block 506, a step of automatically analyzing the communication is provided. The Block 506 is the same as or similar to the Block 206 of FIG. 2 described above.

At Block 508, a step of determining if the communication is noncompliant is provided. The Block 508 is the same as or similar to the Block 208 of FIG. 2 described above.

At Block 510, a step of making the communication available to the whole population is provided if the communication is determined to be not noncompliant. In other words, the communication may be published or otherwise made public without restrictions.

At Block 512, a step of making the communication available to a subset of the plurality of members is provided if the communication is determined to be noncompliant. The Block 512 may be the same as or similar to the Block 210 of FIG. 2.

After the communication is determined to be noncompliant, one or more additional steps or combination of steps may be taken, as described below.

At Block 514, a step of allowing the individual member to modify the noncompliant communication is provided after the communication is made available to the subset of members. The individual member may, for example, modify the noncompliant communication to conform to rules and standards of the DCN.

At Block 516, a step of allowing a member of the subset of members to post an additional communication to the communication string which contains the noncompliant communication is provided after the communication is made available to the subset of members.

Returning to the example where an initial communication includes “I read blood pressure medicine does not work”. The initial communication may be quarantined such that only the subset of members can engage in discussion about their own successful experiences with blood pressure medication and what works for them and add to the communication string. Once the communications from the subset of members are added, the communication string may be published as new context provided by the additional communications gives context to the initial communication. The communication string may provide a useful conversation without value judgements to the individual member who wrote the initial communication and without damaging the individual member's autonomy.

At Block 518, a step of allowing the individual member to post an additional communication to the communication string which contains the noncompliant communication is provided after the communication is made available to the subset of members.

After any of the Blocks 514, 516, and/or 518 have been performed, the resulting communication may be reanalyzed to determine if the resulting communication is noncompliant.

The method described in FIG. 5 may have more or less steps and any steps or combinations of steps may be repeated.

The methods described above in FIGS. 2, 3, 4, and 5 can be used to manage health care cost of the population, reduce health care risk in the population, and/or slow progression of an adverse health condition. More specifically, biometrics are used extensively in both the decision making around the provisioning and commissioning of healthcare. The examples are endless, diabetes is diagnosed, and treatment begun when the level of HbA1c in a patient's blood is over 7 mg/dl. Hypertension drugs are prescribed when a patient's blood pressure exceed a certain value. A cancer drug is available for reimbursement if a certain genetic signature is present in the tumor. The decision tree and other logic behind these relationships considers many things including what is known about the variance in the intervention's efficacy, therapeutic index, the accuracy and precision in the biometrics' measurement, as well as the cost-benefit ratio of the intervention compared with other interventional options.

Lifestyle, environmental, and social group interventions have two characteristics different from other health related interventions. First, they have even more person-to-person variance than drug or surgical interventions, making creating a decision scheme to select the best one in a “feed forward way’ even more difficult. Second, they have very low cost and risk. This should indicate that the decision process should shift from feed forward to “feedback” where you try something and then use the biometric to see if it worked. Of course, “feed forward” logic can be used to suggest things to try, but medical practitioners can also use intuition, preference, and what they have learned from previous attempts to guide the choice.

Thus, health care in a population can be improved by providing a means for members of said population to interact in a DCN without risking loss of that community if a user's posts accidently violate the DCN's standards. The DCN may monitor new posts to determine the post they meet the established standards.

Further, similarly to controlling the spread of disinformation, various embodiments can help prevent negative communications and encourage an active online community. This allows the community to share their experiences and helps in slowing the progression of an adverse health condition in a population. By fostering an atmosphere where users share information freely, the members of the population may be made more aware of the adverse health condition (or health risks) and empowered to slow the progression. In some cases, this can include stopping the progression of the adverse health condition or, even, reversing the advancement of the adverse health condition.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6A, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid-state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6A may be connected to, or be a part of, a network. For example, as shown in FIG. 6B, the network (620) may include multiple nodes (e.g., node X (622) and node Y (624), as well as extant intervening nodes between node X (622) and node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6A. Further, the client device (626) may include or perform all or a portion of one or more embodiments.

The computing system of FIG. 6A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

Various operations described are purely exemplary and imply no particular order. Further, the operations can be used in any sequence when appropriate and can be partially used. With the above embodiments in mind, it should be understood that additional embodiments can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and otherwise manipulated.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. Modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A method to rehabilitate messages in a digital communication network (DCN), the method comprising:
providing the DCN for a plurality of members of a population to interact with each other and the DCN;
receiving a communication of a plurality of communications in the DCN from an individual member of the plurality of members;
automatically analyzing the communication;
determining if the communication is noncompliant; and
limiting access of the communication to a subset of members of the plurality of members in response to determining that the message is noncompliant.

2. The method of claim 1, wherein the communication is part of a communication string, and wherein the communication is evaluated in the context of the communication string.

3. The method of claim 2, further comprising:
receiving at least one of a new communication added to the communication string or a modification to the communication string; and
reanalyzing the communication based on at least one of the new communication or the modification.

4. The method of claim 2, wherein the subset of members can add communications to the communication string.

5. The method of claim 1, wherein the subset of members is determined, in part, by at least one of: a type of noncompliance, a degree of noncompliance, through analysis of the subset of members interactions DCN, and a topic of the communication string.

6. The method of claim 1, wherein analyzing the communication comprises classifying a type of noncompliance of the communication.

7. The method of claim 6, wherein the type of noncompliance communication comprises, at least one of:
an obscene message,
a message that disparages a group or individual,
a message with misinformation,
a message which is cruel,
a message with commercial intent,
a message with inappropriate medical advice,
a message with confusing or out of context advice,
a message with unsafe advice,
a message with illegal content,
a message which discourages adoption of a health behavior, and
a message which diminishes self-efficacy or agency.

8. The method of claim 1, wherein analyzing the communication comprises classifying a degree of noncompliance of the communication.

9. The method of claim 2, wherein the subset of members can communicate directly with the individual member.

10. The method of claim 1, further comprising:
providing the individual member an interface to modify the communication to generate a revised communication;
receiving the revised communication; and
communicating the revised communication to the DCN.

11. The method of claim 1, further comprising, in response to determining the communication is noncompliant, flagging the communication in a communication feed.

12. The method of claim 11, wherein the flagging indicates at least one of a type of noncompliance, a degree of noncompliance, or a combination thereof.

13. The method of claim 1, wherein the method is used to at least one of: manage health care cost of the population; reduce health care risk in the population; and slow progression of an adverse health condition.

14. The method in claim 1, wherein the communication string is restricted to the subset of members of the DCN.

15. A method to rehabilitate communications in a digital communication network (DCN), the method comprising:
providing the DCN for a plurality of members of a population to interact with each other and the DCN;
receiving a communication of a plurality of communications in the DCN from an individual member of the plurality of members;
automatically analyzing the communication;
determining if the communication is noncompliant; and
sending, in response to determining the communication is noncompliant, the user a communication containing a link to a second network where the communication would meet online community rules and standards.

16. The method of claim 15, wherein the noncompliant communication comprises at least one of:
an obscene communication,
a communication that disparages a group or individual,
a communication with misinformation,
a communication which is cruel,
a communication with commercial intent,
a communication with inappropriate medical advice,
a communication with confusing or out of context advice,
a communication with unsafe advice,
a communication with illegal content,
a communication which discourages adoption of a health behavior, and
a communication which diminishes self-efficacy or agency.

17. The method of claim 15, wherein the link to the second network is accompanied by a message encouraging the individual member to use the second network to propagate content of the noncompliant communication.

18. The method of claim 15, further comprising, after a time period, sending the individual member an invitation to return to the DCN and share experiences related to interactions on the second network.

19. The method of claim 18, wherein the time period is at least one week.

20. The method of claim 15, wherein the second network is selected automatically based on communications by the individual member.
